(19) United States
(12) Patent Application Publication
(10) Pub. No.: US 2026/0016417 A1
(43) Pub. Date: Jan. 15, 2026

(54) INSPECTION SYSTEM AND METHOD OF INSPECTION

(71) Applicant: Samsung Display Co., LTD., Yongin-si (KR)

(72) Inventors: JAEWOO JUNG, Yongin-si (KR); HYEONSUK GUAK, Yongin-si (KR); YONG-HEE PARK, Yongin-si (KR); INHYE PARK, Yongin-si (KR); EUNJI OH, Yongin-si (KR); SUNGWOO JUNG, Yongin-si (KR)

(21) Appl. No.: 19/053,741

(22) Filed: Feb. 14, 2025

(30) Foreign Application Priority Data
Jul. 10, 2024 (KR) 10-2024-0091003

(51) Int. Cl. G01N 21/65; G06T 7/70

(52) U.S. Cl. CPC G01N 21/65; G06T 7/70; G01N 2201/021

(57) ABSTRACT

An inspection system includes a stage disposed on a plane defined by a first direction and a second direction intersecting the first direction, wherein the stage is rotatable about an axis parallel to the first direction, and a sample is seated on the stage, an aligner which aligns the sample before or after the sample is seated on the stage, an inspector which radiates a laser to a detection position of the sample, and a controller which aligns the stage based on the detection position of the sample.

This application claims priority to Korean Patent Application No. 10-2024-0091003 filed on Jul. 10, 2024, and all the benefits accruing therefrom under 35 U.S.C. § 119, the content of which in its entirety is herein incorporated by reference.

### BACKGROUND

### 1. Field

Embodiments of the disclosure relate to an inspection system and a method of inspection using the inspection system.

### 2. Description of the Related Art

Raman spectroscopy is an analytical technique that radiates a laser to a target sample and determines a composition of a material from a spectrum obtained therefrom. Light is scattered when the target sample is irradiated with the laser, which is a monochromatic light source, and most of the scattered light is a signal corresponding to a wavelength of the laser, but some of the light is a signal that is a Raman shift corresponding to a frequency of a vibration mode of the sample at the wavelength of the laser. By analyzing this signal, information about shape and symmetry of molecules or crystals can be provided, and a degree of crystallization of the sample can be determined. Since a pattern of wavelength change varies depending on a structural characteristics of the material and appears as a unique characteristic for each specific material, the Raman spectrum is called a fingerprint of the material.

### SUMMARY

Embodiments provide an inspection system with improved efficiency.

Embodiments provide a method of inspection using the inspection system.

An inspection system according to an embodiment of the disclosure includes a stage disposed on a plane defined by a first direction and a second direction intersecting the first direction, where the stage is rotatable about an axis parallel to the first direction, and a sample is seated on the stage, an aligner which aligns the sample before or after the sample is seated on the stage, an inspector which radiates a laser to a detection position of the sample, and a controller which aligns the stage based on the detection position of the sample.

In an embodiment, the aligner may include a first aligner which aligns the sample before the sample is seated on the stage, and a second aligner which is spaced apart from the first aligner and aligns the sample after the sample is seated on the stage.

In an embodiment, a lens included in the first aligner may be different from a lens included in the second aligner.

In an embodiment, the inspector may include a Raman spectrometer.

In an embodiment, the inspector may extract image data of the sample in a third direction intersecting each of the first direction and the second direction.

In an embodiment, the inspector may include a first lens, and a second lens having a magnification higher than a magnification of the first lens.

In an embodiment, a working distance of the first lens may be equal to a working distance of the second lens.

In an embodiment, the controller may include a first controller which communicates the detection position of the sample in another inspection, a second controller which calculates a compensation value of the stage based on the detection position of the sample, and a third controller which aligns the stage based on the compensation value of the stage.

In an embodiment, the stage may be movable in the first direction, the second direction, or a third direction intersecting each of the first direction and the second direction.

In an embodiment, the inspection system may further include a loader which loads or unloads the sample onto the stage.

A method of inspection according to an embodiment of the disclosure includes seating a sample on a stage disposed on a plane defined by a first direction and a second direction intersecting the first direction, aligning the sample, obtaining a detection position of the sample, aligning the stage based on the detection position of the sample, and inspecting the detection position of the sample.

In an embodiment, the aligning the sample may include aligning the sample through a first aligner before the seating of the sample on the stage, and aligning the sample through a second aligner after the seating of the sample on the stage.

In an embodiment, a lens included in the first aligner may be different from a lens included in the second aligner.

In an embodiment, the obtaining the detection position of the sample may include communicating the detection position of the sample in another inspection through a first controller, and extracting image data of the sample in a third direction intersecting each of the first direction and the second direction through an inspector.

In an embodiment, the aligning the stage according to the detection position of the sample may include calculating a compensation value of the stage based on the detection position of the sample through a second controller, and aligning the stage based on the compensation value of the stage through a third controller.

In an embodiment, the stage may be movable in the first direction, the second direction, or the third direction, and may be rotatable about an axis parallel to the first direction.

In an embodiment, the inspecting the detection position of the sample may include radiating a laser to the detection position of the sample through the inspector.

In an embodiment, the inspector may include a Raman spectrometer.

In an embodiment, the inspector may include a first lens, and a second lens having a magnification higher than a magnification of the first lens, where a working distance of the first lens may be equal to a working distance of the second lens.

In an embodiment, the inspector may extract the image data using the first lens, and may radiate the laser using the second lens.

In an inspection system and a method of inspection according to embodiments of the disclosure, movement, alignment, inspection, or the like of a sample may all be performed automatically. The sample may be moved by a loader and precisely aligned by an aligner, and inspection of a detection position of the sample may be performed by a controller and an inspector. In addition, since a stage on which the sample is seated is rotatable, even if the detection position of the sample is located on a curved portion of the sample, inspection and analysis thereof may be effectively preformed. Accordingly, inspection and analysis time for the sample may be reduced, and since a material of the sample may be utilized through non-destructive analysis, process efficiency may be improved.

### BRIEF DESCRIPTION OF THE DRAWINGS

FIG. 1 is a perspective view schematically illustrating an inspection system according to an embodiment of the disclosure.

FIG. 2 is a view illustrating a stage included in the inspection system of FIG. 1.

FIGS. 3, 4, 5, 6, 7, 8, 9, 10, and 11 are views illustrating a method of inspection according to an embodiment of the disclosure.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. “At least one” is not to be construed as limiting “a” or “an.” “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, embodiments of the disclosure will be described in more detail with reference to the accompanying drawings. The same or like reference numerals are used for the same or like components in the drawings, and any repetitive detailed descriptions of the same or like components will be omitted.

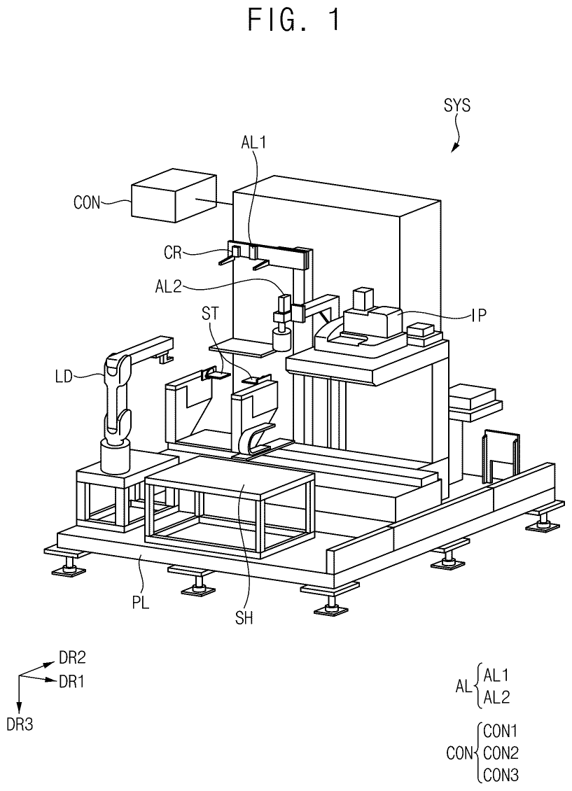

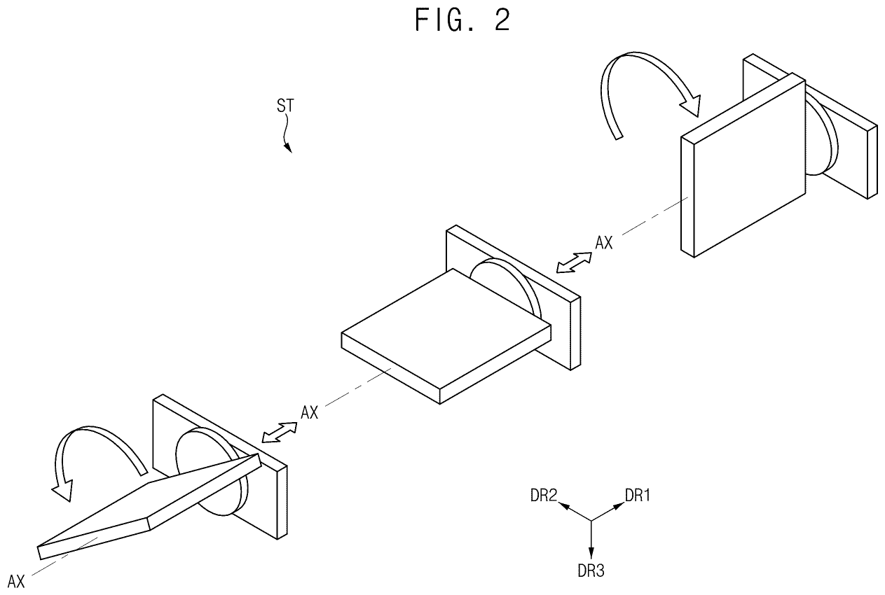

FIG. 1 is a perspective view schematically illustrating an inspection system according to an embodiment of the disclosure. FIG. 2 is a view illustrating a stage included in the inspection system of FIG. 1.

Referring to FIGS. 1 and 2, an embodiment of an inspection system SYS may include a plate PL, a shuttle SH, a loader LD, a reader CR, an aligner AL, a stage ST, an inspector IP, and a controller CON.

The inspection system SYS may be used in a manufacturing process of a display device. In an embodiment, for example, the inspection system SYS may be used in a process of inspecting a foreign substance included in the display device during the manufacturing process of the display device. However, the disclosure is not limited thereto, and the inspection system SYS may be used in various processes of inspecting the display device during the manufacturing process of the display device.

The plate PL may be disposed on or parallel to a plane defined by a first direction DR1 and a second direction DR2 intersecting the first direction DR1. In an embodiment, for example, the first direction DR1 and the second direction DR2 may be perpendicular.

The shuttle SH may be disposed on the plate PL. An inspection object may be inserted and disposed on the shuttle SH in a unit of a tray. The shuttle SH may support the inspection object inserted into the inspection system SYS. In an embodiment, for example, the shuttle SH may be movable in the first direction DR1 or a direction opposite to the first direction DR1.

The loader LD may be disposed on the plate PL. The loader LD may be disposed adjacent to the shuttle SH. In an embodiment, for example, the loader LD may be an articulated (e.g., six-axis) robot arm. The loader LD may load or unload the inspection object. The loader LD may move the inspection object. In an embodiment, for example, the loader LD may load the inspection object from the shuttle SH and unload the inspection object to the stage ST, or may load the inspection object from the stage ST and unload it to the shuttle SH.

The reader CR may be disposed on the plate PL. The reader CR may read unique information of the inspection object. In an embodiment, for example, the reader CR may read a cell identification (ID) of the inspection object.

The aligner AL may be disposed on the plate PL. The aligner AL may include a first aligner AL1 and a second aligner AL2 spaced apart from each other. The aligner AL may align (or change a position of) the inspection object. In an embodiment, the aligner AL may align the inspection object in the first direction DR1 and the second direction DR2.

In an embodiment, the first aligner AL1 and the second aligner AL2 may sequentially align the inspection object. In an embodiment, for example, the first aligner AL1 may first align the inspection object, and then the second aligner AL2 may align the inspection object.

The aligner AL may include a camera module. In an embodiment, for example, the aligner AL may capture an image in a third direction DR3 intersecting each of the first direction DR1 and the second direction DR2. In an embodiment, for example, the third direction DR3 may be perpendicular to each of the first direction DR1 and the second direction DR2. The aligner AL may recognize an image of the inspection object in the third direction DR3 to align the inspection object.

In an embodiment, the first aligner AL1 and the second aligner AL2 may include different lenses. In an embodiment, for example, the second aligner AL2 may include a lens that is relatively more precise than a lens included in the first aligner AL1. The second aligner AL2 may include a lens that has relatively less distortion than a lens included the first aligner AL1. In an embodiment, for example, the first aligner AL1 may include a macro lens, and the second aligner AL2 may include a telecentric lens.

The stage ST may be disposed on the plate PL. The stage ST may be disposed on or parallel to the plane defined by the first direction DR1 and the second direction DR2. The stage ST may be movable in the first direction DR1, the direction opposite to the first direction DR1, the second direction DR2, a direction opposite to the second direction DR2, the third direction DR3, or a direction opposite to the third direction DR3.

In an embodiment, the stage ST may be rotatable about an axis AX parallel to the first direction DR1. The axis AX may be an imaginary extension line that is parallel to the first direction DR1 and passes through a center of the stage ST. In an embodiment, for example, the stage ST may be rotatable about 90 degrees in a clockwise direction around the axis AX, and may be rotatable about 90 degrees in a counterclockwise direction around the axis AX (see FIG. 2). That is, the stage ST may be movable about four-axes. The inspection object may be seated on the stage ST.

Although FIG. 1 illustrates an embodiment where the inspection system SYS includes two stages ST, the disclosure is not limited thereto. In embodiments of the disclosure, a number of the stage ST included in the inspection system SYS is not limited, and the inspection system SYS may include one or more stages ST.

The inspector IP may be disposed on the plate PL. The inspector IP may include a camera module. The inspector IP may capture an image of the inspection object in the third direction DR3. In an embodiment, for example, the inspector IP may obtain or extract image data of the inspection object in the third direction DR3.

In addition, the inspector IP may radiate a laser to the inspection object. In an embodiment, the inspector IP may include a Raman spectrometer. The inspector IP may analyze light scattered from the inspection object to inspect the inspection object.

The inspector IP may include a first lens and a second lens. In an embodiment, the second lens may have a magnification higher than a magnification of the first lens. That is, the first lens may be a low-magnification lens, and the second lens may be a high-magnification lens. The first lens and the second lens may be automatically changed. In an embodiment, a working distance of the first lens may be equal to a working distance of the second lens. Here, the working distance may be defined as a distance from a front end of the first lens and the second lens to an upper surface of the inspection object.

The controller CON may include a first controller CON1, a second controller CON2, and a third controller CON3. The controller CON may control components included in the inspection system SYS (e.g., the loader LD, the stage ST, or the like). The controller CON may include a circuitry.

The first controller CON1 may communicate other inspection results of the inspection object. In an embodiment, for example, the first controller CON1 may communicate coordinates of a detection position (e.g., a defective position) of the inspection object in other inspection. The other inspection may be an inspection previously performed. The other inspection may be an image quality inspection of the inspection object, an appearance inspection of the inspection object, or the like.

The second controller CON2 may calculate a value at which the stage ST should be aligned. The second controller CON2 may calculate a compensation value of the stage ST based on the detection position of the inspection object seated on the stage ST. In addition, the second controller CON2 may match result of the inspection object inspected by the inspector IP with a database, and may transmit data of the inspection object (e.g., to the first controller CON1, external device, or the like).

The third controller CON3 may control a component to be driven in the inspection system SYS. In an embodiment, the third controller CON3 may control an operation of the stage ST. The third controller CON3 may align the stages ST based on the compensation value calculated by the second controller CON2.

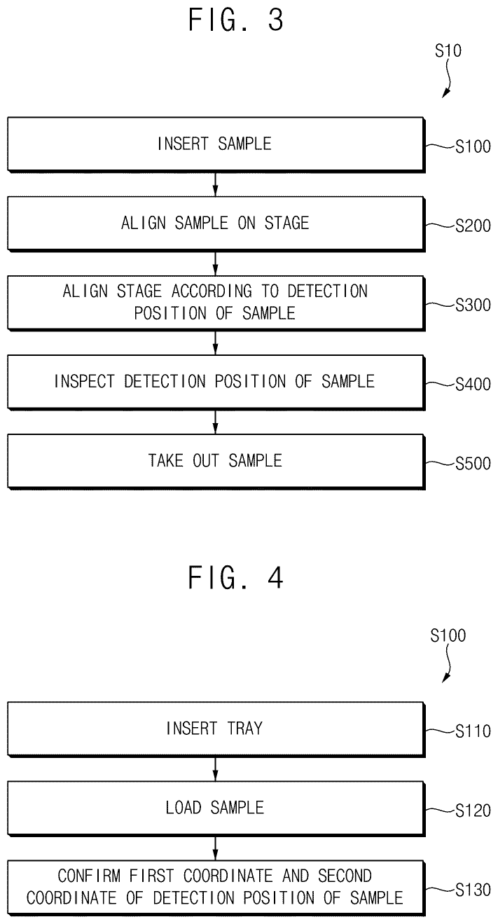

FIGS. 3, 4, 5, 6, 7, 8, 9, 10, and 11 are views illustrating a method of inspection according to an embodiment of the disclosure. For example, a method (S10) of inspection described with reference to FIGS. 3, 4, 5, 6, 7, 8, 9, 10, and 11 may be performed using the inspection system SYS described with reference to FIGS. 1 and 2. Hereinafter, any repetitive detailed descriptions of the same or like elements as those described above will be omitted or simplified.

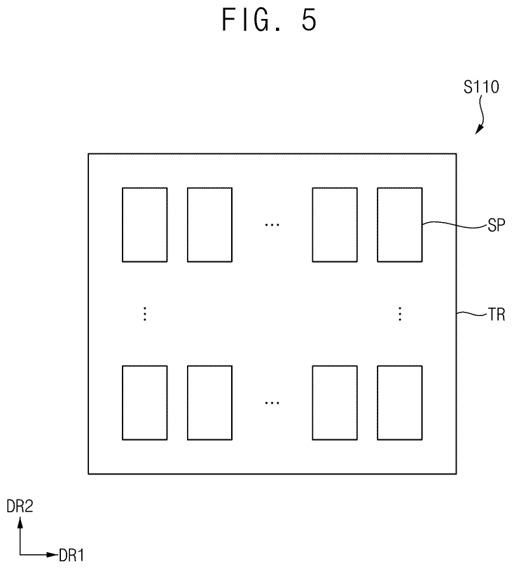

FIG. 3 is a flowchart illustrating an embodiment of the method (S10) of inspection. FIG. 4 may be a flowchart illustrating an embodiment of a process (S100) of inserting a sample SP, and FIG. 5 may be a view illustrating an embodiment of a process (S110) of inserting a tray TR.

Referring to FIGS. 1, 3, 4, and 5, in an embodiment of the method (S10) of inspection, the sample SP may be inserted into the inspection system SYS (S100). The sample SP may correspond to the inspection object.

In an embodiment, the sample SP may be a display device being manufactured. In an embodiment, for example, the sample SP may include a substrate, an inorganic layer, an organic layer, a metal layer, a window, or the like included in the display device.

In the injecting of the sample SP (S100), the tray TR on which the sample SP is disposed may be inserted into the inspection system SYS (S110). In an embodiment, for example, the sample SP may be inserted in a unit of the tray TR. A plurality of samples SP may be arranged on the tray TR in the first direction DR1 and the second direction DR2. The tray TR on which the samples SP are arranged may be disposed on the shuttle SH and inserted into the inspection system SYS. In an embodiment, for example, the tray TR may be inserted into the inspection system SYS, and the shuttle SH may support the tray TR and move in the direction opposite to the first direction DR1.

In the injecting of the sample SP (S100), the loader LD may load the sample SP (S120). The loader LD may load (or pick up) one of the samples SP on the tray TR disposed on the shuttle SH disposed adjacent to the loader LD. In an embodiment, for example, the loader LD may be an articulated robot arm. The loader LD may move the loaded sample SP. The loader LD may move the sample SP close to the reader CR.

In the injecting of the sample SP (S100), a first coordinate and a second coordinate of a detection position DP of the sample SP may be confirmed (S130). Here, the detection position DP may be a defective (e.g., foreign matter or the like) position of the sample SP, the first coordinate may be an X-coordinate (e.g., a coordinate in the first direction DR1), and the second coordinate may be a Y-coordinate (e.g., a coordinate in the second direction DR2).

The reader CR may read unique information of the sample SP (e.g., cell ID of the sample SP) moved by the loader LD, and the first controller CON1 may communicate a coordinate of other inspection results of the sample SP through the unique information. In an embodiment, the first controller CON1 may communicate the first coordinate and the second coordinate of the detection position DP of the sample SP in other inspection. In an embodiment, for example, where the sample SP is a display device being manufactured, the other inspection may include an image quality inspection that inspects a defect by driving the sample SP, an appearance inspection that inspects a defect without driving the sample SP, or the like. In an embodiment, the first controller CON1 may transmit the first coordinate and the second coordinate of the detection position DP of the sample SP to the third controller CON3.

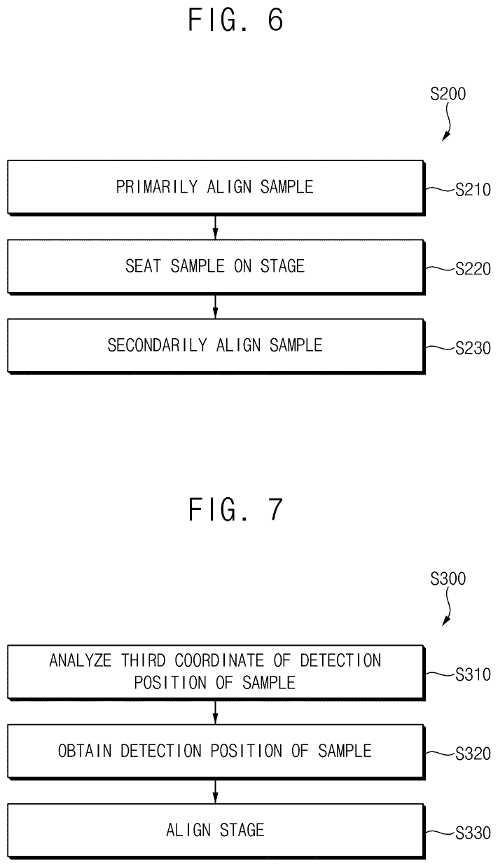

FIG. 6 is a flowchart illustrating an embodiment of a process (S200) of aligning the sample SP on the stage ST.

Referring to FIGS. 1, 3, and 6, in an embodiment of the method (S10) of inspection, the sample SP may be aligned on the stage ST (S200).

In the aligning of the sample SP on the stage ST (S200), the first aligner AL1 may primarily align the sample SP (S210).

The first aligner AL1 may capture an image of the sample SP moved by the loader LD, and may primarily align the sample SP. In an embodiment, for example, the first aligner AL1 may recognize a corner of the sample SP in the third direction DR3 to align the first and second directions DR1 and DR2 of the sample SP. In an embodiment, the first aligner AL1 may include a macro lens. In an embodiment, for example, an error range of the first aligner AL1 may be about several hundred micrometers.

In the aligning of the sample SP on the stage ST (S200), the sample SP may be seated on the stage ST (S220).

The loader LD may unload the sample SP onto the stage ST. That is, the loader LD may seat the sample SP primarily aligned by the first aligner AL1 on the stage ST. The stage ST on which the sample SP is seated may be moved toward the second aligner AL2 (e.g., in the first direction DR1).

In the aligning of the sample SP on the stage ST (S200), the second aligner AL2 may secondarily align the sample SP (S230).

The second aligner AL2 may capture an image of the sample SP seated on the stage ST, and may secondarily align the sample SP. In an embodiment, for example, the second aligner AL2 may recognize the corner of the sample SP in the third direction DR3 to align the first and second directions DR1 and DR2 of the sample SP. In an embodiment, the second aligner AL2 may include a telecentric lens. In an embodiment, for example, an error range of the second aligner AL2 may be about 30 micrometers. Since the second aligner AL2 includes a lens which is relatively more precise and has less distortion than the first aligner AL1, the sample SP may be more precisely aligned. Since the sample SP is sequentially and automatically aligned by the first aligner AL1 and the second aligner AL2, the inspection system SYS may repeatedly and precisely align the sample SP on the stage ST.

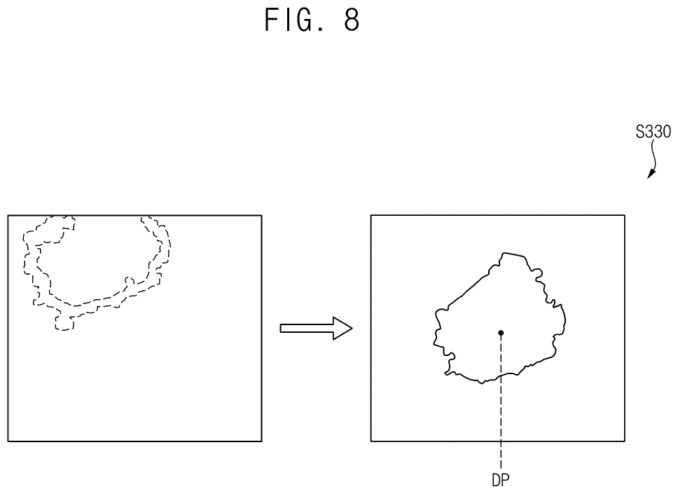

FIG. 7 may be a flowchart illustrating an embodiment of a process (S300) of aligning the stage ST according to (or based on) the detection position DP of the sample SP, and FIG. 8 may be a view illustrating an embodiment of a process (S330) of aligning the stage ST.

Referring to FIGS. 1, 3, 7, and 8, in an embodiment of the method (S10) of inspection, the stage ST may be aligned according to (or based on) the detection position DP of the sample SP (S300).

In the aligning of the stage ST according to the detection position DP of the sample SP (S300), a third coordinate of the detection position DP of the sample SP may be analyzed by the inspector IP (S310). Here, the third coordinate may be a Z-coordinate (e.g., a coordinate in the third direction DR3).

The inspector IP may capture an image of the sample SP in the third direction DR3 to extract image data of the sample SP in the third direction DR3. In an embodiment, for example, the third controller CON3 may move the stage ST in a way such that the first coordinate and the second coordinate of the detection position DP of the sample SP correspond to an imaging position of the inspector IP, and the inspector IP may capture an image of the detection position DP of the sample SP in the third direction DR3 to extract image data of the detection position DP of the sample SP in the third direction DR3.

In such an embodiment, first, the inspector IP may recognize an uppermost surface of the sample SP with the first lens (e.g., a 10× lens). Thereafter, the inspector IP may scan an image for a predetermined range in an area where a predetermined thickness is lowered from the uppermost surface in consideration of thickness, refractive index, or the like of an uppermost layer of the sample SP to extract image data for layers below the uppermost layer.

In an embodiment, for example, where the sample SP is a display device being manufactured, the inspector IP may scan an image for a predetermined range in an area where a predetermined thickness is lowered from an uppermost surface in consideration of thickness, refractive index, or the like of a window of the sample SP, and may extract three-dimensional (3D) image data for layers below the window (i.e., organic layer, inorganic layer, metal layer, or the like). In an embodiment, for example, the inspector IP may extract 3D image data for an area of about ±125 micrometers (μm) after lowering about 400 μm from the uppermost surface in consideration of thickness, refractive index, or the like of the window, but the disclosure is not limited thereto.

Through the extracted image data, the inspector IP may confirm the third coordinate of the detection position DP. That is, the third coordinate may be obtained from the first coordinate and the second coordinate of the detection position DP by the inspector IP.

In the aligning of the stage ST according to (or based on) the detection position DP of the sample SP (S300), the detection position DP of the sample SP may be obtained (S320).

The second controller CON2 may calculate the compensation value of the stage ST according to (or based on) the first coordinate, the second coordinate, and the third coordinate of the detection position DP of the sample SP. That is, the second controller CON2 may calculate the compensation value of the stage ST according to (or based on) the detection position DP of the sample SP and an inspection position of the inspector IP.

In the aligning of the stage ST according to the detection position DP of the sample SP (S300), the stages ST may be aligned (S330).

The third controller CON3 may drive and align the stage ST according to (or based on) the compensation value calculated by the second controller CON2. The stage ST may be moved in the first direction DR1, the direction opposite to the first direction DR1, the second direction DR2, the direction opposite to the second direction DR2, the third direction DR3, or the direction opposite to the third direction DR3 according to (or based on) the detection position DP of the sample SP. In addition, when the detection position DP of the sample SP is located on the curved portion of the sample SP, the stage ST may rotate around the axis AX parallel to the first direction DR1 according to (or based on) the detection position DP of the sample SP. Accordingly, the stage ST may be moved in a way such that the detection position DP of the sample SP and the inspection position of the inspector IP correspond to each other.

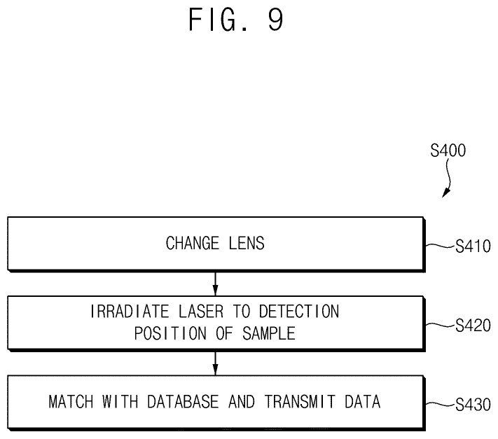

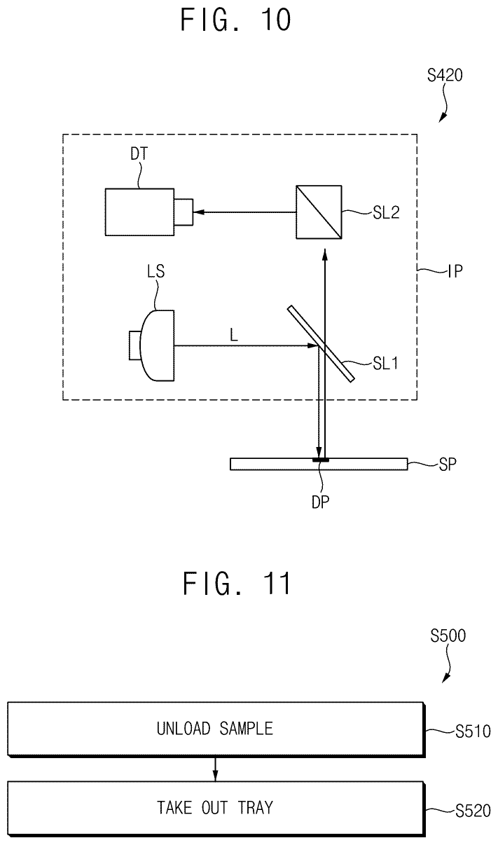

FIG. 9 may be a flowchart illustrating an embodiment of a process (S400) of inspecting the detection position DP of the sample SP, and FIG. 10 may be a view illustrating an embodiment of a process (S420) of radiating a laser to the detection position DP of the sample SP.

Referring to FIGS. 1, 3, 9, and 10, in an embodiment of the method (S10) of inspection, the detection position DP of the sample SP may be inspected (S400).

In the inspecting of the detection position DP of the sample SP (S400), the lens of the inspector IP may be changed (S410).

In an embodiment, the lens of the inspector IP may be automatically changed from the first lens (e.g., a 10× lens) to the second lens (e.g., a 50× lens). The working distance of the first lens and the working distance of the second lens may be the same. That is, the working distance of the low-magnification lens may be equal to the working distance of the high-magnification lens.

In the inspecting of the detection position DP of the sample SP (S400), a laser may be radiated to the detection position DP of the sample SP (S420). The inspector IP may include a Raman spectrometer, and may perform a Raman inspection. The Raman inspection may be an inspection that measures a molecular structure and optical properties of a material using Raman spectroscopy.

The Raman spectroscopy uses Raman scattering, which changes a wavelength of light, and measures vibrational energy of a material by observing a decrease or increase in energy of scattered light compared to Rayleigh scattering. A spectrum indicates a shift amount of the scattered light as a Raman shift, and the Raman shift corresponds to a vibration frequency of a molecule. Qualitative and quantitative analysis of the material may be performed using a spectrum in which intensity of the scattered light is indicated as a band or series of peaks according to frequency.

In an embodiment, as shown in FIG. 10, the inspector IP may include a light source LS, a first splitter SL1, a second splitter SL2, and a detector DT. The inspector IP may perform Raman inspection on the detection position DP of the sample SP located at the inspection position of the inspector IP.

The light source LS may emit a laser L having a specific wavelength. The laser L emitted from the light source LS may be reflected from the first splitter SL1 and incident (i.e., radiated) on the sample SP. The laser L incident on the sample SP may be reflected from the sample SP again, pass through the first splitter SL1, be reflected from the second splitter SL2, and be incident on the detector DT. The detector DT may detect a Raman spectrum from the laser L incident on the detector DT. Accordingly, by analyzing the Raman spectrum detected from the detector DT, the inspector IP may inspect a component included in the sample SP (e.g., a component of a foreign material located at the detection position DP of the sample SP).

Although not illustrated in FIG. 10, at least one mirror or lens may be further disposed between the light source LS, the first splitter SL1, the second splitter SL2, and the detector DT. In an embodiment, for example, the at least one mirror or lens may include a flat mirror, a convex mirror, a concave mirror, or the like. The at least one mirror or lens may focus the laser L, disperse the laser L, or change a path of the laser L.

In the inspecting of the detection position DP of the sample SP (S400), inspection result for the detection position DP of the sample SP may be matched with a database, and data for the detection position DP of the sample SP may be transmitted (S430).

The second controller CON2 may match the inspection result for the detection position DP of the sample SP inspected by the inspector IP with the database, and may analyze a component of the detection position DP. In addition, the second controller CON2 may transmit the data for the detection position DP of the sample SP. In an embodiment, for example, the second controller CON2 may transmit the data to the first controller CON1, the external device, or the like.

FIG. 11 is a flowchart illustrating an embodiment of a process (S500) of taking out the sample SP.

Referring to FIGS. 1, 3, and 11, in an embodiment of the method (S10) of inspection, the sample SP may be taken out (S500).

In the taking out of the sample SP (S500), the loader LD may unload the sample SP (S510). The loader LD may load (or pick up) the sample SP disposed on the stage ST and unload the sample SP onto the shuttle SH. That is, the loader LD may return the sample SP whose inspection has been completed back to the shuttle SH.

Thereafter, when an uninspected sample SP remains in the tray TR, the loader LD may load the uninspected sample SP (S120). Until inspection of all the samples SP disposed on the tray TR is completed, the loading of the sample SP by the loader LD (S110) to the unloading of the sample SP by the loader LD (S510) may be repeatedly performed.

In the taking out of the sample SP (S500), the tray TR on which the sample SP is disposed may be taken out from the inspection system SYS (S520). When the inspection of all the samples SP disposed on the tray TR is completed, the tray TR on which the samples SP whose inspection has been completed are arranged may be disposed on the shuttle SH and taken out from the inspection system SYS. In an embodiment, for example, the shuttle SH may support the tray TR and move in the first direction DR1, and the tray TR may be taken out from the inspection system SYS.

In the inspection system SYS and the method (S10) of inspection according to embodiments of the disclosure, movement, alignment, inspection, or the like of the sample SP may all be performed automatically. The sample SP may be moved by the loader LD and precisely aligned by the aligner AL, and inspection of the detection position DP of the sample SP may be performed by the controller CON and the inspector IP. In addition, since the stage ST on which the sample SP is seated is rotatable, even if the detection position DP of the sample SP is located on the curved portion of the sample SP, inspection and analysis thereof may be effectively performed. Accordingly, inspection and analysis time for the sample SP may be reduced, and since a material of the sample SP may be utilized through non-destructive analysis, process efficiency may be improved.

The disclosure can be applied to a manufacturing process of various display devices and electronic devices. For example, the disclosure is applicable to a manufacturing process of various display devices such as display devices for vehicles, ships and aircraft, portable communication devices, display devices for exhibition or information transmission, medical display devices, or the like.

The invention should not be construed as being limited to the embodiments set forth herein. Rather, these embodiments are provided so that this disclosure will be thorough and complete and will fully convey the concept of the invention to those skilled in the art.

While the invention has been particularly shown and described with reference to embodiments thereof, it will be understood by those of ordinary skill in the art that various changes in form and details may be made therein without departing from the spirit or scope of the invention as defined by the following claims.

What is claimed is:

1. An inspection system comprising:
a stage disposed on a plane defined by a first direction and a second direction intersecting the first direction, wherein the stage is rotatable about an axis parallel to the first direction, and a sample is seated on the stage;
an aligner which aligns the sample before or after the sample is seated on the stage;
an inspector which radiates a laser to a detection position of the sample; and
a controller which aligns the stage based on the detection position of the sample.

2. The inspection system of claim 1, wherein the aligner includes:
a first aligner which aligns the sample before the sample is seated on the stage; and
a second aligner which is spaced apart from the first aligner and aligns the sample after the sample is seated on the stage.

3. The inspection system of claim 2, wherein a lens included in the first aligner is different from a lens included in the second aligner.

4. The inspection system of claim 1, wherein the inspector includes a Raman spectrometer.

5. The inspection system of claim 1, wherein the inspector extracts image data of the sample in a third direction intersecting each of the first direction and the second direction.

6. The inspection system of claim 1, wherein the inspector includes:
a first lens; and
a second lens having a magnification higher than a magnification of the first lens.

7. The inspection system of claim 6, wherein a working distance of the first lens is equal to a working distance of the second lens.

8. The inspection system of claim 1, wherein the controller includes:
a first controller which communicates the detection position of the sample in another inspection;
a second controller which calculates a compensation value of the stage based on the detection position of the sample; and
a third controller which aligns the stage based on the compensation value of the stage.

9. The inspection system of claim 1, wherein the stage is movable in the first direction, the second direction, or a third direction intersecting each of the first direction and the second direction.

10. The inspection system of claim 1, further comprising:
a loader which loads or unloads the sample onto the stage.

11. A method of inspection, the method comprising:
seating a sample on a stage disposed on a plane defined by a first direction and a second direction intersecting the first direction;
aligning the sample;
obtaining a detection position of the sample;
aligning the stage based on the detection position of the sample; and
inspecting the detection position of the sample.

12. The method of claim 11, wherein the aligning the sample includes:
aligning the sample through a first aligner before the seating the sample on the stage; and
aligning the sample through a second aligner after the seating the sample on the stage.

13. The method of claim 12, wherein a lens included in the first aligner is different from a lens included in the second aligner.

14. The method of claim 11, wherein the obtaining the detection position of the sample includes:
communicating the detection position of the sample in another inspection through a first controller; and
extracting image data of the sample in a third direction intersecting each of the first direction and the second direction through an inspector.

15. The method of claim 14, wherein the aligning the stage based on the detection position of the sample includes:
calculating a compensation value of the stage based on the detection position of the sample through a second controller; and
aligning the stage based on the compensation value of the stage through a third controller.

16. The method of claim 14, wherein
the stage is movable in the first direction, the second direction, or the third direction, and is rotatable about an axis parallel to the first direction.

17. The method of claim 14, wherein the inspecting the detection position of the sample includes:
radiating a laser to the detection position of the sample through the inspector.

18. The method of claim 17, wherein the inspector includes a Raman spectrometer.

19. The method of claim 17, wherein the inspector includes:
a first lens; and
a second lens having a magnification higher than a magnification of the first lens,
wherein a working distance of the first lens is equal to a working distance of the second lens.

20. The method of claim 19, wherein the inspector extracts the image data using the first lens and radiates the laser using the second lens.
